(19) United States
(12) Patent Application Publication
(10) Pub. No.: US 2026/0246754 A1
(43) Pub. Date: Aug. 20, 2026

(54) CHAT SYSTEM AND CHAT PROCESSING METHOD

(71) Applicant: Hideaki MATSUYAMA, Kanagawa (JP)

(72) Inventor: Hideaki MATSUYAMA, Kanagawa (JP)

(21) Appl. No.: 19/161,471

(22) PCT Filed: Jul. 31, 2023
(86) PCT No.: PCT/JP2023/027987

§ 371 Date: Sep. 2, 2025

(30) Foreign Application Priority Data
Mar. 2, 2023 (JP) 2023-032099

(51) Int. Cl. H04L 51/216; G06F 3/0482

(52) U.S. Cl. CPC H04L 51/216; G06F 3/0482

(57) ABSTRACT

A chat system and chat processing method provide easy posting. A chat system is connected via a communication network to user terminals including a host user terminal to enable chatting, and includes a control device having a display processing function to display a main screen on a display panel of the host user terminal. The main screen has: a chat room selection section that displays chat rooms as selectable; a hierarchical chat creation section that allows a chat belonging to a selected chat room to be added; and a chat list display section that displays chats that belong to the chat room and that can be participated in at the host user terminal. A post can be made to a hierarchical chat selected from the chat list display section. The same content can be posted to each of a plurality of hierarchical chats selected from the chat list display section.

### TECHNICAL FIELD

The present invention relates to a chat system and a chat processing method.

### BACKGROUND ART

In recent years, commercial transactions via a communication network such as the Internet have been performed actively. For example, PTL1 discloses a real estate trading supporting system that analyzes contract possibility information or contract probability information. In PTL1, it is described that the system may be installed with a chat function for supporting communication among a real estate broker, a real estate owner, a sales requester and a purchase requester.

### CITATION LIST

### Patent Literature

PTL1: JP2019-200652A

### SUMMARY OF INVENTION

### technical problem

In business communication, there is a case that it is desired to change a communication method depending on the situation. However, it is complicated to use different communication methods properly according to the circumstances.

The present invention is made in consideration of the above-described problem, and an object thereof is to provide a chat system and a chat processing method that make it easy to Select a posting form and that are highly convenient.

### Solution to Problem

A chat system to attain the purpose hereinbefore is a chat system that is connected via a communication network to a plurality of user terminals including at least one host user terminal to enable chatting, and includes a controller having a display processing function to display a main screen on a display panel of at least the host user terminal, wherein the main screen has: a chat room selection unit displaying, as selectable, a chat room in which the host user terminal can be participated and to which at least one chat can belong; a hierarchical chat creation unit capable of adding at least one hierarchical chat belonging to the chat room selected, where each of the hierarchical chats is a one-to-one chat or a group chat of more than three persons including a host user; and a chat list display unit that displays, as selectable, the chat which belongs to the chat room selected and which can be participated in at the host user terminal; and being capable of making a post to each of the hierarchical chats selected from the chat list display unit and furthermore capable of posting the same content in a batch to each of a plurality of the hierarchical chats selected from the chat list display unit.

A chat processing method to attain the purpose hereinbefore is a chat processing method achieved by a controller connected via a communication network to a plurality of user terminals including at least one host user terminal to enable chatting, and including: a step of displaying a main screen on a display panel of at least the host user terminal; a step of displaying a chat room selection unit that displays a chat room in which the host user terminal can be participated and to which at least one chat can belong, on the main screen; a step of displaying a hierarchical chat creation unit capable of adding at least one hierarchical chat belonging to the chat room selected, where each of the hierarchical chats is a one-to-one chat or a group chat of more than three persons including a host user, on the main screen; a step of displaying a chat list display unit that displays, as selectable, the chat which belongs to the chat room selected and which can be participated in at the host user terminal, on the main screen; and a step of posting the same content in a batch to each of a plurality of the hierarchical chats selected from the chat list display unit.

### Advantageous Effects of Invention

The chat system and the chat processing method can select and post a one-to-one hierarchical chat or a group hierarchical chat in a chat room as well as can post the same content in a batch to a plurality of hierarchical chats regardless of a one-to-one chat or a group chat. Therefore, the chat system and the chat processing method make it easy to select a posting form and are highly convenient.

The chat system may be able to display a grouping unit that selects at least two of the chats and that creates a new chat room to which the chats selected belong. This assures that the chat system can select a plurality of chats that already exist and create a new chat.

The main screen may have a state switching unit capable of switching a state of displaying the hierarchical chat belonging to the chat room and a state of displaying a normal chat that doesn't have a chat room to which it belongs. This assures that the chat system can switch the main screen to the state of displaying a hierarchical chat or the state of displaying a normal chat, depending on the situation, resulting in making it easy to select a posting form and improving the convenience.

In at least one state of either a state of displaying the hierarchical chat belonging to the chat room or a state of displaying a normal chat that doesn't have a chat room to which it belongs, the main screen may be able to display both of the hierarchical chat creation unit and a normal chat creation unit capable of adding the normal chat. This assures that, without switching the main screen to the state of displaying a hierarchical chat or the state of displaying a normal chat, the chat system can select and create a hierarchical chat or a normal chat from the same screen, resulting in improving the convenience.

The main screen may be able to display a creator nonparticipation chat creation unit that enables creating the chat that doesn't include a user of the host user terminal who creates the chat as a participant. This assures that the chat system can create a chat in which a host user doesn't participate, from a main screen, at a host user terminal, resulting in improving the convenience.

The main screen may include a confirmation request display unit that displays, as inputtable, character information to be sent to another user terminal participating in each of the hierarchical chats selected from the chat list display unit, and that furthermore displays, as selectable, a sending unit sending inputted character information to the another user terminal, the controller displaying the character information on the another user terminal as well as displaying a confirmation affirmation unit that can be selected so as to display it on the main screen of the host user terminal that the character information has been confirmed. This assures that the chat system can easily request a confirmation of information from the host user terminal to the other user terminal participating in a hierarchical chat and can easily send it from the other user terminal to the host user terminal that the information has been confirmed, resulting in improving the convenience.

### BRIEF DESCRIPTION OF DRAWINGS

FIG. 1 is a block diagram for illustrating a constitution of a chat system having a control device according to the embodiment.

FIG. 2 is a block diagram for illustrating the physical constitution of the control device.

FIG. 3 shows a screen at the time of a hierarchical chat displayed on the host user terminal by the control device.

FIG. 4 shows a name input screen.

FIG. 5 shows an invitation screen.

FIG. 6 shows an expanded view of the chat list display unit.

FIG. 7 shows a participant display screen.

FIG. 8 shows a screen at the time of grouping.

FIG. 9 shows a screen at the time of a batch transmission.

FIG. 10 shows a screen of the host user terminal sending a message in a group chat belonging to a chat room.

FIG. 11 shows a screen of a guest user terminal receiving a message in a group chat belonging to a chat room.

FIG. 12 shows a screen at the time of a hierarchical chat displayed on the guest user terminal by the control device.

FIG. 13 shows a screen at the time of a normal chat displayed on the host user terminal by the control device.

FIG. 14 shows a sequence chart for describing the flow of a control in the control device of the chat system.

FIG. 15 shows a name input screen of a chat system in an alternate embodiment.

FIG. 16 shows a part of a screen at the time of a hierarchical chat displayed on a host user terminal of a chat system in another alternate embodiment.

FIG. 17 is a block diagram for illustrating a constitution of a chat system further in another alternate embodiment.

FIG. 18 shows a confirmation request display unit displayed on the host user terminal by the control device.

FIG. 19 shows the confirmation request display unit displayed on the guest user terminal by the control device.

FIG. 20 shows a screen of the host user terminal displaying it on the confirmation request display unit that a confirmation request has been confirmed.

FIG. 21 shows a screen displaying an attached file that has been opened.

### DESCRIPTION OF EMBODIMENTS

Hereinafter, embodiments of the present invention are described with reference to the drawings. Note that the dimensions of the drawings may be exaggerated and differ from the actual dimensions for convenience.

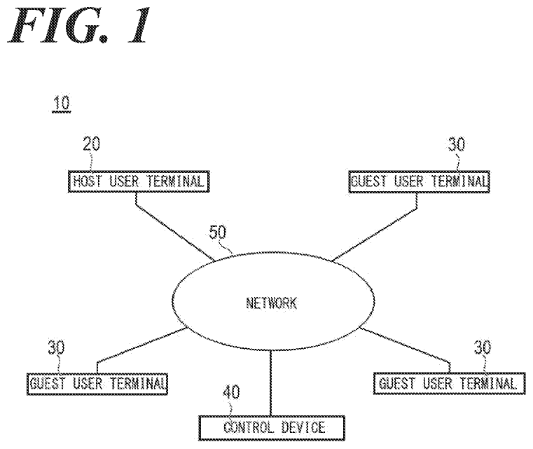

As shown in FIG. 1, a chat system 10 according to the embodiment is a system for communication performed via a communication network 50 such as the Internet and used for business in which related users change mainly for every subject. The chat system 10 is a system managing a plurality of chats in which a plurality of users participates to post electronic files such as messages and images, to browse, and to download electronic files. Note that the chat system 10 may not be for business use.

In the embodiment, described is an instance that a host user who is also at least one of users uses the chat system 10 so as to interact with other plurality of guest users. While the host user can create a chat room and invite users to the chat room, the guest user can neither create a chat room nor invite users to the chat room. There may be a plurality of host users. Moreover, all users may be host users (all users may be able to create a chat room and invite users to the chat room).

For example, a host user is a project manager managing a project. For example, a host user may be a person providing a plurality of products or services, such as, a real estate agent selling real estate such as land and buildings, a business operator related to construction, and a school official. A host user can create a specific chat room for every project. For example, a project can mean a real estate property to be sold, a specific construction work, a class or an event at school, and so on. Note that a person using the chat system is not especially limited.

In the embodiment, described is an instance that a host user is a project manager in real estate trading. In this case, a guest user is a broker brokering real estate trading, an owner buying real estate, a person in charge of design of a construction work of a building, a person in charge of construction, a service provider providing a service in real estate trading.

A service provider is a provider for service accompanying real estate trading. For example, a service provider is a judicial scrivener, a surveyor, a dismantling operator, and so on.

In real estate trading, a judicial scrivener performs a registration of transfer of ownership, a registration of termination of hypothecation, a registration establishment of hypothecation, or the like. Note that a requester for registration is a seller or a buyer of real estate.

In real estate trading, a dismantling operator dismantles a building and the like. Note that a requester for dismantling is a seller or a buyer of real estate.

The chat system 10 has a host user terminal 20 used by the host user who is a main user of the system, a plurality of guest user terminals 30 used by a plurality of users who communicate with the host user, and a control device 40 (controller). There may be a plurality of host user terminals 20. Moreover, the guest user terminal 30 other than the host user terminal 20 may send and receive a chat in chat software different from the chat system 10. Therefore, the chat system 10 can link with different chat software, can make a post and the like on the different chat software, and can receive and browse a post from the different chat software. Moreover, the guest user terminal 30 other than the host user terminal 20 may send and receive a chat in e-mail software.

The host user terminal 20 and the guest user terminal 30 are, for example, composed of a personal computer, a mobile terminal such as a smartphone and a tablet, an exclusive device, or the like.

The control device 40 is communicatively connected via the communication network 50 to the host user terminal 20 and a plurality of the guest user terminals 30. The control device 40 is a mass storage server device or a computer in which a main program completing the chat system 10 via the communication network 50 is executed. The control device 40 may be one server device or a group of computers composed of a plurality of server devices.

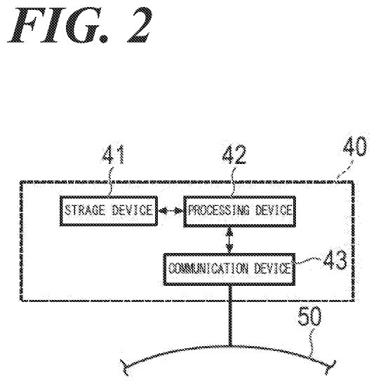

As shown in FIG. 2, the control device 40 includes a storage device 41, a processing device 42, and a communication device 43, as the physical constitution of hardware.

The storage device 41 is, for example, a semiconductor memory element such as an RAM (Random Access Memory) and a Flash Memory, a hard disk, an optical disk, or the like. The storage device 41 can write or read information of users, information of each chat room, a program, and the like, according to the status of a processing. The storage device 41 can write or read information (electronic data) received from the host user terminal 20 and the guest user terminal 30, according to the status of a processing.

The processing device 42 is, for example, a CPU (Central Processing Unit), an MPU (Micro Processing Unit), and so on. The processing device 42 runs a program stored in the storage device 41, with an RAM as an operation area, to perform arithmetic processing, and operates the communication device 43 or the storage device 41, according to the program, to be performed on the communication network 50. That is, the chat system 10 according to the embodiment is stored, for example, in the storage device 41 in the control device 40. Note that the chat system 10 may be executed by cloud computing that uses a plurality of computer resources via the communication network 50.

The communication device 43 is an interface device in order for the control device 40 connected via the communication network 50 to communicate with the host user terminal 20 and each of the guest user terminals 30. The communication device 43 can communicate with a large number of terminals simultaneously.

Subsequently, the control device 40 is described in detail. The control device 40 has a display processing function to display a screen on a display panel of the host user terminal 20 and the guest user terminal 30. The control device 40 has a function to create and register a user account. The control device 40 further specifies a user using a terminal and displays a corresponding screen on the terminal.

The host user and the guest user can register his/her own information on the control device 40 at his/her own terminal. Information of each user is, for example, a name (a term), a member ID, a login password, an e-mail address, and so on. The control device 40 stores these pieces of information.

The control device 40 receives a post or an electronic file sent from the host user terminal 20 and the guest user terminal 30 and manages (stores as readable) these pieces of information. The control device 40 manages an input to a chat, a display of a chat, and sending/receiving a chat, at each terminal. The control device 40 displays a chat screen, corresponding to each terminal.

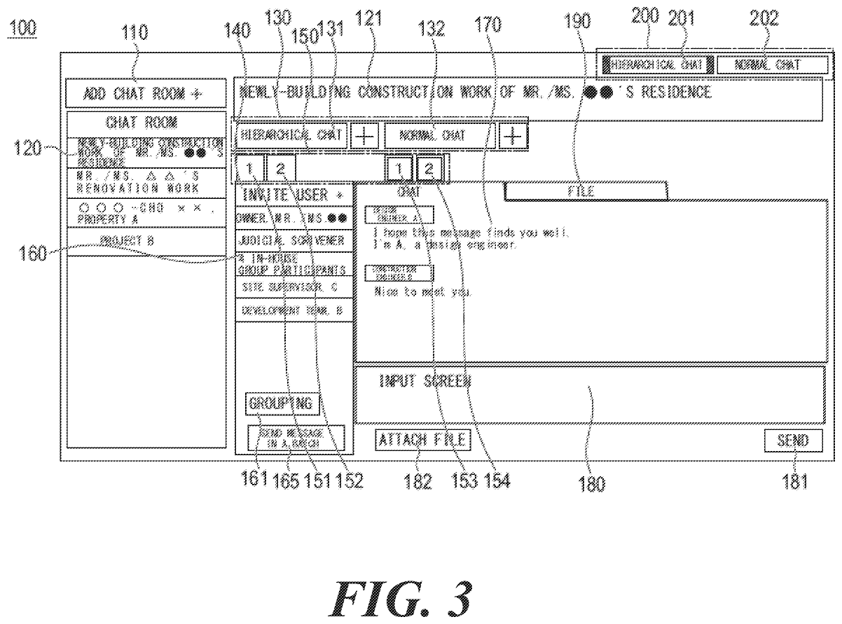

Subsequently, described is a screen displayed on the host user terminal 20 by the control device 40. A main screen 100 displayed on the host user terminal 20 has, as shown in FIG. 3, a chat room addition unit 110, a chat room selection unit 120, a chat room name display unit 121, a chat type selection unit 130, a user invitation unit 140, a chat type specification unit 150, a chat list display unit 160, a chat display unit 170, a chat input unit 180, a file display unit 190, a state switching unit 200, and a batch transmission unit 240. The chat display unit 170 and the file display unit 190 are displayed with a switchable tab so that any one of screens can be displayed. A tab is a GUI (Graphic User Interface) widget for switching a document to be displayed.

A screen displayed on the guest user terminal 30 by the control device 40 may be configured the same as the main screen 100 displayed on the host user terminal 20 but may have a limited configuration.

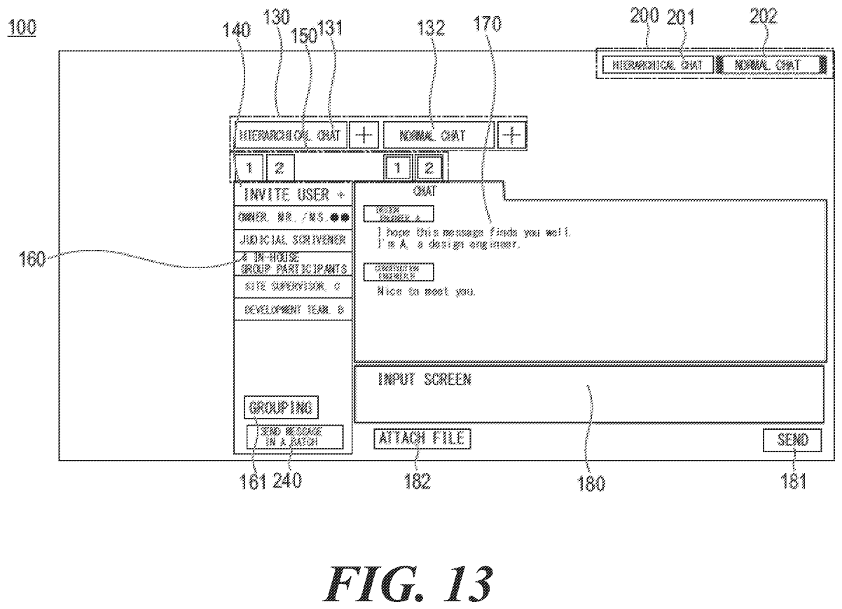

The state switching unit 200 displays a hierarchical chat display selection button 201 and a normal chat display selection button 202. By clicking on the hierarchical chat display selection button 201 at the host user terminal 20, the main screen 100 can switch a screen in which a normal chat is performed (See FIG. 13), and a screen in which performed is a hierarchized-structure chat (a hierarchical chat) where a plurality of chats belong to a chat room which is a characteristic configuration of the embodiment (See FIG. 3), by the control device 40. Clicking on the normal chat display selection button 202 allows for a normal chat where all chats exist in parallel without belonging to a chat room, on the main screen 100. Clicking on the hierarchical chat display selection button 201 allows for a hierarchical chat where a plurality of chats can exist in parallel under one chat room, on the main screen 100. Note that clicking means selecting on a screen with a cursor such as a pointer and performing so as to exhibit a function of a site which the cursor pointing at, by a click button of a mouse, a run button on a keyboard, or the like. As long as clicking is selected so that the function of the site can be exhibited, methods thereof are not limited.

While a normal chat is being displayed after the normal chat display selection button 202 being clicked on, as shown in FIG. 13, the control device 40 may change, for example, a color and a shape of the normal chat display selection button 202, to a color and a shape different from the hierarchical chat display selection button 201, so as to show that the normal chat is being displayed. Furthermore, while a hierarchical chat is being displayed after the hierarchical chat display selection button 201 being clicked on, as shown in FIG. 3, the control device 40 may change, for example, a color and a shape of the hierarchical chat display selection button 201, to a color and a shape different from the normal chat display selection button 202, so as to show that the hierarchical chat is being displayed. Note that displays of the hierarchical chat display selection button 201 and the normal chat display selection button 202 on the main screen 100 are characters of “HIERARCHICAL CHAT” and “NORMAL CHAT” in FIGS. 3 and 13, but not limited to these, which can be set suitably with characters, symbols, graphics, or the like that a user can specify. Note that the same is true of a display of a site having another function.

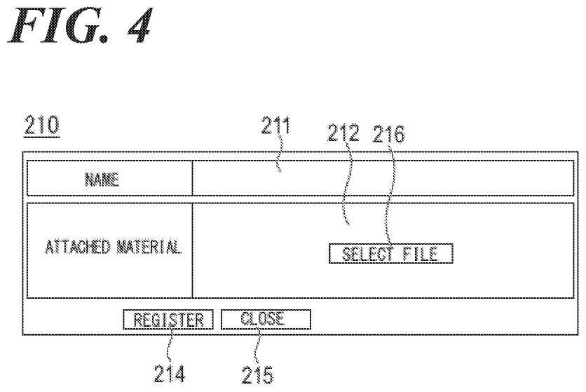

Hereinafter, mainly, described is a hierarchical chat selected by the hierarchical chat display selection button 201, as shown in FIG. 3. The chat room addition unit 110 is used when creating a new chat room. By being clicked on at the host user terminal 20, the chat room addition unit 110 displays a name input screen 210 for inputting a name of the new chat room on the host user terminal 20, as shown in FIG. 4.

On the name input screen 210, displayed are a name input unit 211 capable of inputting a name, a material attachment unit 212 capable of attaching a material, a register button 214, and a close button 215. The name input unit 211 can input a name at the host user terminal 20. The material attachment unit 212 can attach an electronic file desired to be attached, at the host user terminal 20, by dragging and dropping, or by specifying and selecting a storage location of the electronic file with a file selection button 216. An attached electronic file can be selected from the file display unit 190 to be browsed. The register button 214 becomes ready to be clicked on at the host user terminal 20, by inputting on at least the name input unit 211, of the name input unit 211 and the material attachment unit 212. When the register button 214 is clicked on, a chat room of an inputted name is created as well as the name and an attached material are stored in the control device 40 in association with the same chat room. Any user who participates in the same chat room can browse the attached material from the file display unit 190. Note that, on the name input screen 210, a memorandum or the like may be inputtable. A memorandum is stored in the control device 40 in the same way as a name and an attached material.

As shown in FIG. 3, the chat room selection unit 120 displays names of a plurality of chat rooms that have been created, as selectable. When a name of one chat room is selected by, for example, clicking, at the host user terminal 20, a chat room selected is displayed on the chat display unit 170 as well as the chat list display unit 160 and the chat display unit 170 are switched to a content of the selected chat room.

The chat room name display unit 121 displays a name of the selected chat room.

The chat type selection unit 130 is used so as to select a type of a chat to be created in a specific chat room being selected, or of a normal chat. A plurality of chats can belong to each of chat rooms. The chat type selection unit 130 has a hierarchical chat creation unit 131 capable of selecting a hierarchical chat, and a normal chat creation unit 132 capable of selecting a normal chat. When the hierarchical chat creation unit 131 is selected by, for example, clicking, at the host user terminal 20, a hierarchical chat becomes ready to be created in this chat room. When the normal chat creation unit 132 is selected by, for example, clicking, at the host user terminal 20, a normal chat that doesn't belong to a chat room becomes ready to be created. A name of a created chat room can be inputted at the host user terminal 20. A name of a chat may be set in a state ready to be inputted, for example, by selecting a specific chat by double-clicking or the like from the chat list display unit 160 and can be set by being inputted. Note that, when the normal chat creation unit 132 is selected and a normal chat is created at the host user terminal 20, the main screen 100 is switched to a screen displaying a general normal chat, in the same way as the normal chat display selection button 202 is selected, as shown in FIG. 13.

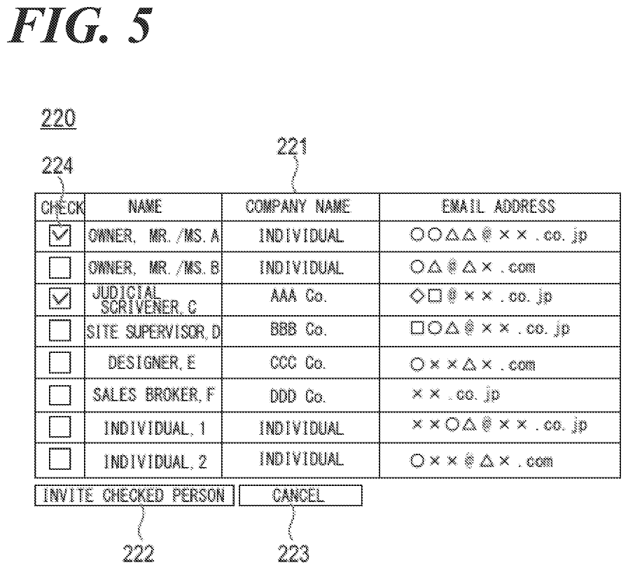

The user invitation unit 140 is used to invite a user to a created chat, as shown in FIG. 3. When the user invitation unit 140 is clicked on at the host user terminal 20, as shown in FIG. 5, an invitation screen 220 is displayed on the host user terminal 20. On the invitation screen 220, displayed are a user list 221, an invitation button 222, and an invitation cancel button 223. In the user list 221, displayed are, for example, a guest checkbox 224 as well as a name of a user ready to be invited, a company name, an email address, and so on. When the invitation button 222 is clicked on, at the host user terminal 20, in a state that one or more of the guest checkboxes 224 are checked, a user selected by the guest checkbox 224 is invited to the created chat. The invited user is automatically stored in an address book installed in the control device 40, in association with the chat. The control device 40 sends a message indicating that he/she has been invited, on the chat, to a guest user terminal of the invited user or the host user terminal 20. The invited user can decide whether or not he/she accepts the invitation, at his/her own guest user terminal 30 in the case of a guest user, or at his/her own host user terminal 20 in the case of a host user.

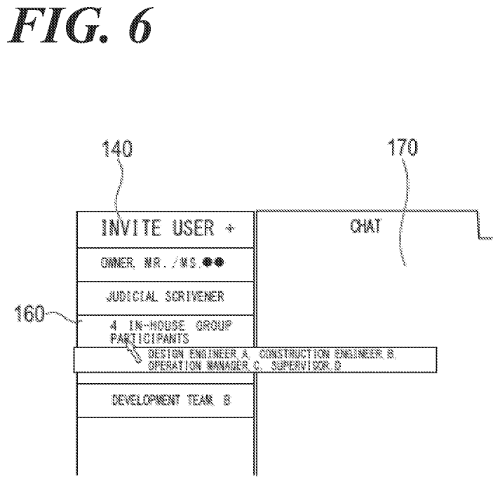

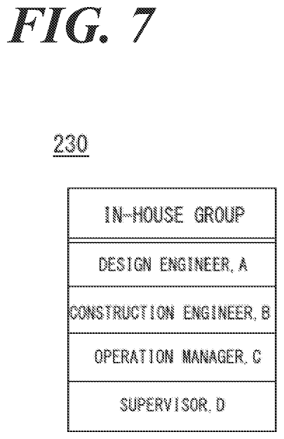

As shown in FIG. 3, the chat list display unit 160 displays names of all chats in which a host user who is a user of his/her own terminal is included as a participant, in a list, of all chats created in a chat room being selected. When a name of one specific chat is selected by, for example, clicking, at the host user terminal 20, the control device 40 changes a color and a shape of a display of the name of the chat so as to show a user that it has been selected, as specifiable, and displays a post content of the selected chat on the chat display unit 170. When a name of a specific chat on the chat list display unit 160 is on mouse over (in a state that a mouse pointer is over), participants of the chat are displayed, as shown in FIG. 6. This assures that opposite chat parties can be displayed on the same screen without switching screens by a button or the like, which is visually understandable. Moreover, when a name of a specific chat on the chat list display unit 160 is, for example, double-clicked on, a list of participants of the chat is displayed as a participant display screen 230, as shown in FIG. 7. Note that a name of a chat is determined based on a prescribed rule if it has not been set. For example, the name may be an enumeration of names of participants, a number of participants, and so on.

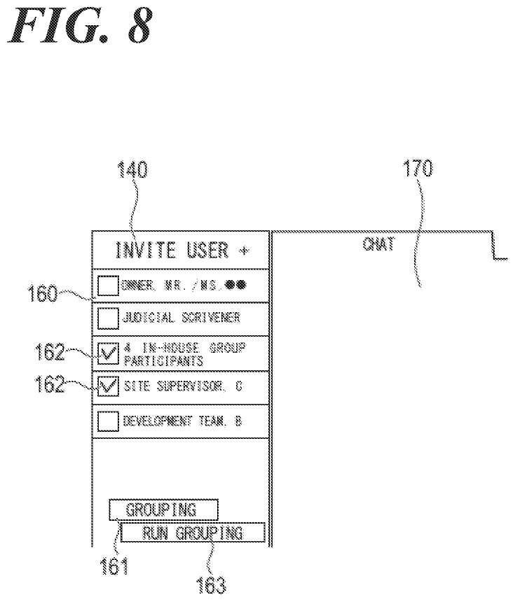

Moreover, as shown in FIGS. 3 and 8, a grouping unit 161 may be displayed on the chat list display unit 160. When the grouping unit 161 is, for example, clicked on, the control device 40 displays a checkbox 162, corresponding to each chat displayed on the chat list display unit 160, as well as displays one grouping run button 163. When checkboxes 162 of two or more chats are selected at the host user terminal 20, a grouping run button 163 becomes ready to be clicked on. When the grouping run button 163 is clicked on, the control device 40 creates a new chat room which all chats that are selected in the check boxes 162 belong to, and displays the name input screen 210 for inputting a name of the new chat room, as shown in FIG. 4 shown in FIG. 4. When the register button 214 is clicked on, the name of the new chat room is added in the chat room selection unit 120. As participants are stored in the address book in the control device 40, participants of a selected chat can be invited (duplicated) to each chat. A plurality of chats ready to be grouped may be only one-to-one chats, may be only group chats (chats of more than three persons in total including a host user), or may include both a one-to-one chat and a group chat.

The grouping unit 161 may be displayed in any chat room, in a state that a hierarchical chat is ready to be performed with the hierarchical chat display selection button 201, as shown in FIG. 3, but also may be displayed in a state that a normal chat which is not hierarchized is ready to be performed with the normal chat display selection button 202, as shown in FIG. 13. If a new chat room is created by grouping normal chats in a state that a normal chat is ready to be performed, it is preferable that the main screen 100 is automatically switched to a state that a hierarchical chat is ready to be performed, as shown in FIG. 3.

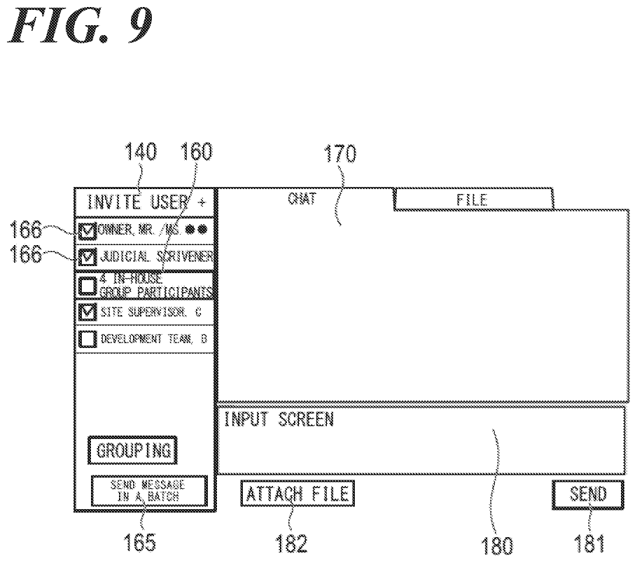

Moreover, as shown in FIG. 3, a batch transmission unit 165 may be displayed on the chat list display unit 160. The batch transmission unit 165 is a unit for sending a common message to a plurality of chats in a chat room, in a batch. When the batch transmission unit 165 is clicked on at the host user terminal 20, as shown in FIG. 9, the control device 40 displays checkboxes 166 capable of selecting a chat in which a message is desired to be sent by clicking on the chat list display unit 160. A host user can input a message in the chat input unit 180, attach an electronic file with the file attachment button 182 if needed, and post the message or the electronic file in a batch to each of all chats selected, with the send button 181. Note that it is not notified to an opposite user who has received this message that the post has been sent in a batch. Therefore, the post sent in a batch is made separately in each chat. Respective hierarchical chats are just independent different chats, which enables posting and browsing only in each hierarchical chat, after being posted in a batch, the independence of each hierarchical chat being maintained.

The chat list display unit 170 displays a post content of a chat that is selected on the chat list display unit 160, as shown in FIG. 3. The chat list display unit 170 displays a post content posted in a selected chat, downward from above (or upward from below), so as to be new and in a time-series manner.

The chat input unit 180 is a unit temporarily inputting characters at the host user terminal 20. Characters temporarily inputted in the chat input unit 180 are posted formally by clicking on the send button 181 displayed near the chat input unit 180 at the host user terminal 20 and are displayed on the chat list display unit 170. A post content that is formally posted is displayed on the chat list display unit 170 of all the host user terminals 20 and the guest user terminals 30 participating in this chat.

Moreover, when the file attachment button 182 displayed near the chat input unit 180 is clicked on at the host user terminal 20, an electronic file becomes ready to be posted on the chat input unit 180. After the file attachment button 182 is pressed on, it becomes ready to be attached by specifying and selecting a storage location of the electronic file.

The chat type specification unit 150 is a unit capable of specifying a type of a chat to be created (a one-to-one (corresponding) hierarchical chat, a group hierarchical chat, a one-to-one normal chat, or a group normal chat) before inviting a user. Therefore, the chat type specification unit 150 is a hierarchical chat creation unit creating a hierarchical chat as well as a normal chat creation unit creating a normal chat. The chat type specification unit 150 displays a first button 151 indicating a one-to-one chat of a hierarchical chat, a second button 152 indicating a group chat of a hierarchical chat, a third button 153 indicating a one-to-one chat of a normal chat, and a fourth button 154 indicating a group chat of a normal chat.

In order to create a new one-to-one chat being a hierarchical chat in this chat room, when the first button 151 is clicked on, the control device 40 displays the invitation screen 220 (See FIG. 5) at the host terminal 20, so that one guest can be selected. When a guest is selected on the invitation screen 220, the control device 40 creates a new one-to-one chat being a hierarchical chat in this chat room.

In order to create a new group chat being a hierarchical chat in this chat room, when the second button 152 is clicked on, the control device 40 displays the invitation screen 220 (See FIG. 5) at the host terminal 20, so that a plurality of guests can be selected. When the plurality of guests are selected on the invitation screen 220, the control device 40 creates a new group chat being a hierarchical chat in this chat room.

In order to create a new one-to-one chat being a normal chat, when the third button 153 is clicked on, the control device 40 displays the invitation screen 220 (See FIG. 5) at the host terminal 20, so that one guest can be selected.

When a guest is selected on the invitation screen 220, the control device 40 creates a new one-to-one chat being a normal chat, not in this chat room, but as a normal chat. When a normal chat is created at the host user terminal 20, the main screen 100 is switched to a screen displaying a general normal chat, in the same way as the normal chat display selection button 202 is selected, as shown in FIG. 13.

In order to create a group chat being a normal chat, when the fourth button 154 is clicked on, the control device 40 displays the invitation screen 220 (See FIG. 5) at the host terminal 20, so that a plurality of guests can be selected. When a plurality of guests is selected on the invitation screen 220, the control device 40 creates a group chat being a normal chat, not in this chat room, but as a normal chat. When a normal chat is created at the host user terminal 20, the main screen 100 is switched to a screen displaying a general normal chat, in the same way as the normal chat display selection button 202 is selected, as shown in FIG. 13.

As shown in FIGS. 3 and 13, in creating a new chat, even if either a normal chat or a hierarchical chat is selected on the state switching unit 200, all types of chats (a one-to-one normal chat, a group normal chat, a one-to-one hierarchical chat, and a group hierarchical chat) can be created by a selection on the chat type selection unit 130 or on the chat type specification unit 150. This assures that a type of a chat can be selected to create a new chat without switching the state switching unit 200, even if a normal chat or a hierarchical chat is selected on the state switching unit 200, which is convenient.

If the normal chat display selection button 202 is selected to display a normal chat, the control device 40 displays a chat that is stored by being defined as a normal chat without the existence of a chat room to which it belongs, on the chat list display unit 160. At this point, the control device 40 is set so as not to display a hierarchical chat with the existence of a chat room to which it belongs, on the chat list display unit 160, but may be set so as to display the hierarchical chat independent of a chat room, on the chat list display unit 160.

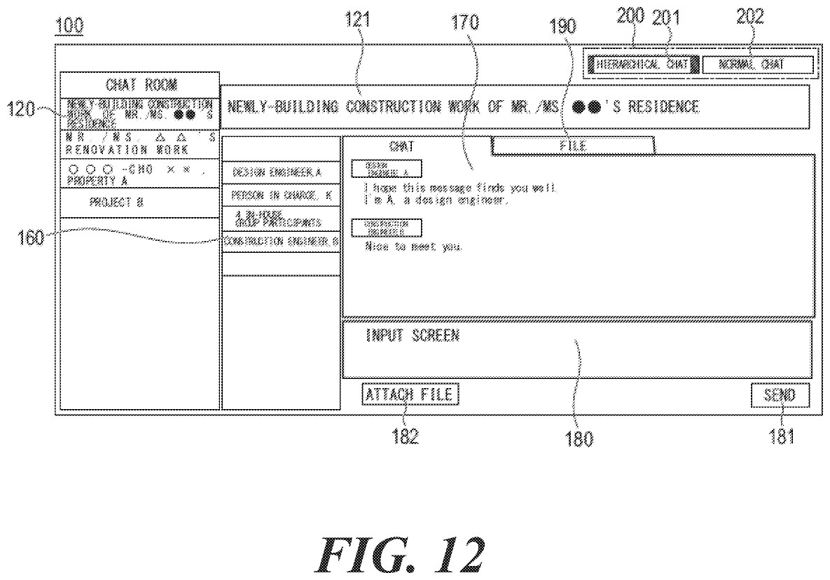

The control device 40 preferably displays only units related to functions which a guest user can use, on the main screen 100 displayed on the guest user terminal 30. For example, as shown FIG. 12, the control device 40 can display the chat room selection unit 120, the chat room name display unit 121, the chat list display unit 160, the chat display unit 170, the chat input unit 180, the file display unit 190, the send button 181 the file attachment button 182, and the state switching unit 200, on the main screen 100 displayed on the guest user terminal 30. On the main screen 100 displayed on the guest user terminal 30, the control device 40 may display the chat room addition unit 110, the chat type selection unit 130, the user invitation unit 140, the chat type specification unit 150, and the batch transmission unit 240, but may not display them.

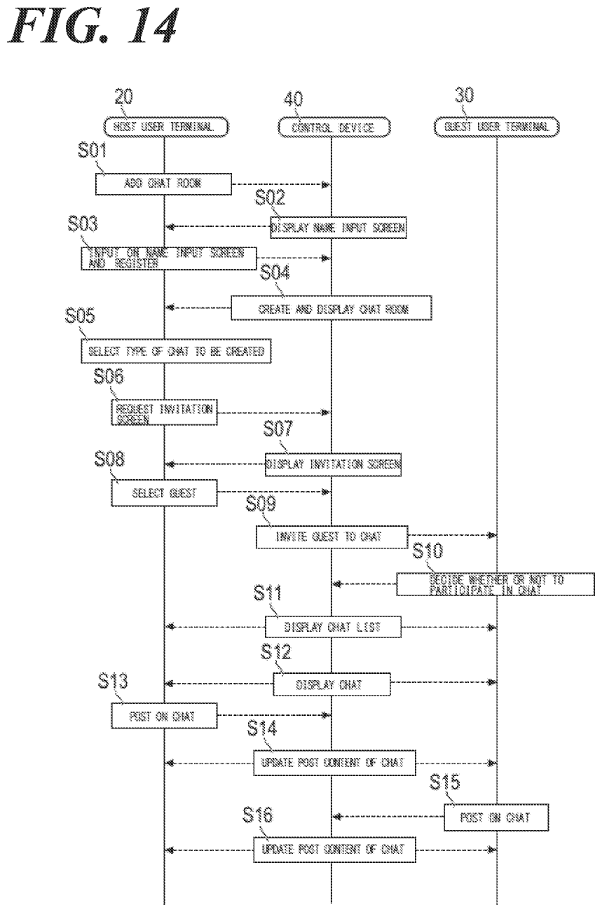

Subsequently, an example of a processing in the control device 40 is described with reference to the sequence chart shown in FIG. 14.

A host user can create one chat room, for example, for one specific subject. The one subject is, for example, a specific event, a specific product, a specific service, a specific real estate property, and so on. In a state that a hierarchical chat is displayed by clicking on the hierarchical chat display selection button 201 of the main screen 100 shown in FIG. 3 at the host user terminal 20, the host user clicks on the chat room addition unit 110 and creates one chat room (Step S01). In accordance with this, the control device 40 displays the name input screen 210 shown in FIG. 4, on the host user terminal 20 (Step S02). The host user inputs a name of a new chat room on the name input unit 211 of the name input screen 210 at the host user terminal 20 (Step S03) and attaches an electronic file on the material attachment unit 212, if needed. When the register button 214 is clicked on at the host user terminal 20, the control device 40 creates a chat room based on its information and changes a display of the main screen 100 shown in FIG. 3. Specifically, the control device 40 adds and displays a new chat room on the chat room selection unit 120 of the main screen 100 (Step S04). Moreover, the control device 40 displays a name of a newly created chat room on the chat room name display unit 121 of the main screen 100. Note that, when a name of another chat room on the chat room selection unit 120 is clicked on, the control device 40 displays the name of the chat room on the chat room name display unit 121. Furthermore, the control device 40 displays names of chats in which this host user is participating, of chats belonging to this chat room, on the chat list display unit 160 of the main screen 100, in a list. This assures that, in a state that a specific chat room is selected, a host user can select optionally a specific chat from a plurality of chats in this chat room, to post and browse.

Subsequently, in a chat room, the host user can create a chat belonging to this chat room. The host user clicks on and selects the hierarchical chat creation unit 131 or the normal chat creation unit 132 of the chat type selection unit 130 of the main screen 100, at the host user terminal 20 (Step S05).

Subsequently, the host user clicks on the user invitation unit 140 of the main screen 100, at the host user terminal 20 (Step S06). In accordance with this, the control device 40 displays the invitation screen 220 shown in FIG. 5, on the host user terminal 20 (Step S07). The host user selects a guest from the invitation screen 220 and checks the guest checkbox 224 for a user who is to be invited (Step S08), at the host user terminal 20. When the invitation button 222 is clicked on, at the host user terminal 20, in a state that one or more of the guest checkboxes 224 are checked, the control device 40 sends a message indicating that he/she has been invited, and a button for answering whether or not to participate (whether or not to accept the invitation) (not shown), on a chat, to a guest user terminal 30 of an invited user (Step S09). The invited user decides and sends whether or not to accept the invitation, at his/her own guest terminal 30 (Step S10). Note that a chat may be created from the aforesaid chat type specification unit 150.

The control device 40 adds a new chat on the chat list display unit 160 of the main screen 100 shown in FIG. 3 and displays all chats which belong to this chat room and furthermore in which this host user is participating (Step S11). Note that, when another chat on the chat list display unit 160 is clicked on, the control device 40 makes the chat active and displays a post content of the chat on a chat display unit 170 of a host user terminal 20 and of a guest user terminal 30, of users participating in this chat (Step S12).

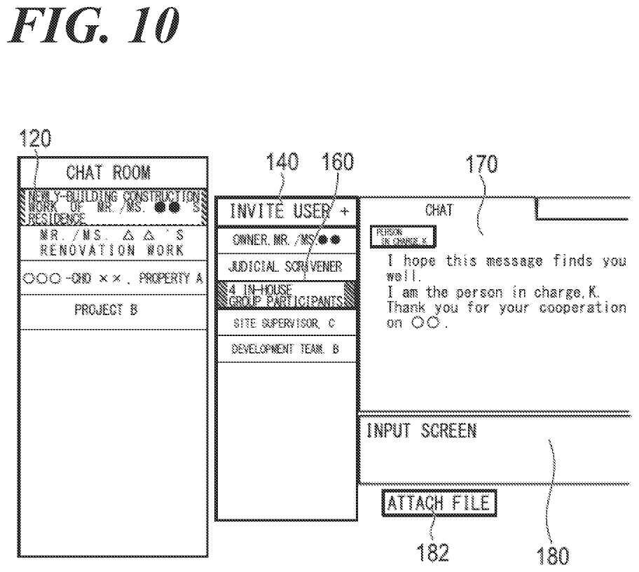

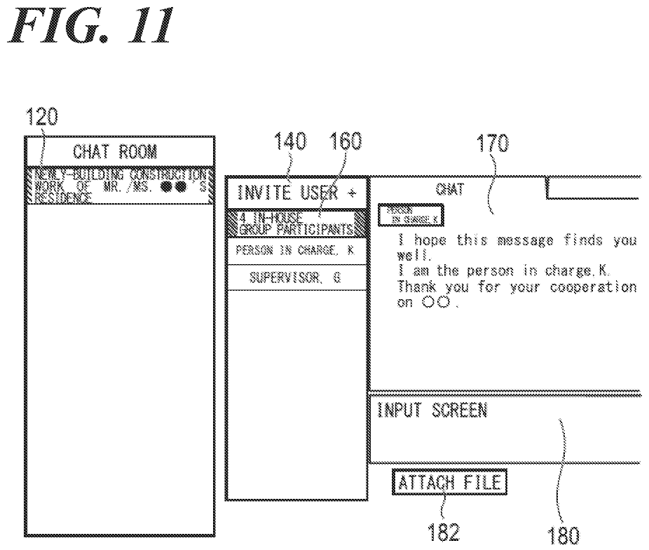

Subsequently, in a chat room, the host user posts a message or an electronic file in a selected specific chat. By temporarily inputting characters on the chat input unit 180 of the main screen 100, and/or attaching an electronic file with the file attachment button 182, to click on the send button 181, at the host user terminal 20, the host user can post character information and/or the electronic file on a chat (Step S13), as shown in FIG. 10. When a message or an electronic file is posted at the host user terminal 20, so as to include its content, the control device 40 updates and displays a post content of the chat display unit 170 of the host user terminal 20 and of the guest user terminal 30 (Step S14), as shown in FIGS. 10 and 11.

When a message or an electronic file is posted at the guest user terminal 30 (Step S15), so as to include its content, the control device 40 updates and displays a post content of the chat display unit 170 of the host user terminal 20 and of the guest user terminal 30 (Step S16).

If a type of a selected chat is a one-to-one normal chat or a group normal chat, a content that the host user has posted is sent to all users invited to participate in this chat. All participants are displayed on the chat display unit 170, in a host user terminal 20 and a guest user terminal 30 of each participant. Moreover, each participant can browse post contents of all the participants as well as can post in this chat at his/her own guest user terminal 30.

If a type of a selected chat is a one-to-one hierarchical chat or a group hierarchical chat, a content that the host user has posted is sent to all other users invited to participate in this chat. A chat room to which a chat to be received belongs and the chat are displayed, on the chat room selection unit 120, the chat room name display unit 121, the chat list display unit 160, and the chat display unit 170, in a host user terminal 20 and a guest user terminal 30, of each participant. Moreover, each participant can browse post contents of all the participants as well as post in a chat belonging to this chat room, at his/her own host user terminal 20 or guest user terminal 30.

As above, the chat system 10 according to the embodiment is a chat system 10 that is connected via a communication network 50 to a plurality of user terminals including at least one host user terminal 20 to enable chatting, and includes a control device 40 (controller) having a display processing function to display a main screen 100 on a display panel of at least the host user terminal 20, wherein the main screen 100 has: a chat room selection unit 120 displaying, as selectable, a chat room in which the host user terminal 20 can be participated and to which at least one chat can belong; hierarchical chat creation units 131, 150 capable of adding at least one hierarchical chat belonging to the chat room selected, where each of the hierarchical chats is a one-to-one chat or a group chat of more than three persons in total including a host user; and a chat list display unit 160 that displays, as selectable, the chat which belongs to the chat room selected and which can be participated in at the host user terminal 20; and being capable of making a post to each of the hierarchical chats selected from the chat list display unit 160 and furthermore capable of posting the same content in a batch to each of a plurality of the hierarchical chats selected from the chat list display unit 160.

Furthermore, the chat processing method in the embodiment is a chat processing method achieved by a control device 40 connected via a communication network 50 to a plurality of user terminals including at least one host user terminal 20 to enable chatting, and including: a step of displaying a main screen 100 on a display panel of at least the host user terminal 20; a step of displaying a chat room as selectable which the host user terminal can be participated in and to which at least one chat can belong, on the main screen 100; a step of displaying hierarchical chat creation units 131, 150 capable of adding at least one hierarchical chat belonging to the chat room selected, where each of the hierarchical chats is a one-to-one chat or a group chat of more than three persons in total including a host user, on the main screen 100; a step of displaying a chat list display unit 160 that displays, as selectable, the chat which belongs to the chat room selected and which can be participated in at the host user terminal 20, on the main screen 100; and a step of posting the same content in a batch to each of a plurality of the hierarchical chats selected from the chat list display unit 160.

This assures that the chat system 10 and the chat processing method can select and post a one-to-one hierarchical chat or a group hierarchical chat as well as can post the same content in a batch to a plurality of hierarchical chats regardless of a one-to-one chat or a group chat, in a chat room. Note that, in a batch post, respective hierarchical chats are just independent different chats, which enables posting and browsing only in each hierarchical chat after being posted in a batch, the independence of each hierarchical chat being maintained. Therefore, the chat system 10 makes it easy to select a posting form and can improve the convenience. Note that the chat list display unit 160 that displays as selectable a chat which can be participated in and the chat list display unit 160 that displays as selectable a hierarchical chat to be posted in a batch are the same display units in the embodiment but also may be different display units.

The chat system 10 may be able to display the grouping unit 161 that selects at least two of the chats and that creates a new chat room to which the chats selected belong. This assures that the chat system 10 can select a plurality of chats that already exist and create a new chat. Note that a chat ready to be grouped may be either a hierarchical chat or a normal chat.

In a case of selecting a plurality of hierarchical chats that belong to the same chat room and creating a new chat room, it is highly convenient to be able to select participants from the hierarchical chats that already exist in the same chat room in creating a new chat room, as the hierarchical chats in the same chat room are possibly relevant to the same subject.

The main screen 100 has the state switching unit 200 capable of switching a state of displaying the hierarchical chat belonging to the chat room and a state of displaying a normal chat that doesn't have a chat room to which it belongs. This assures that the chat system 10 can switch the main screen 100 to the state of displaying a hierarchical chat or the state of displaying a normal chat, depending on the situation, resulting in improving the convenience.

In at least one state of either a state of displaying the hierarchical chat belonging to the chat room or a state of displaying a normal chat that doesn't have a chat room to which it belongs, the main screen 100 can display simultaneously both hierarchical chat creation units 131, 150 and normal chat creation units 132, 150 capable of adding a normal chat. This assures that, without switching the main screen 100 to the state of displaying a hierarchical chat or to the state of displaying a normal chat, the chat system 10 can select and create a hierarchical chat or a normal chat from the same screen, resulting in improving the convenience.

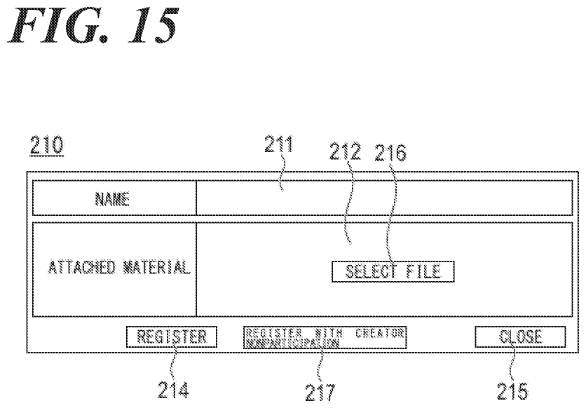

Note that the present invention is not limited to the embodiments described above and can be variously changed by a person skilled in the art in the technical idea of the invention. For example, as in an alternate embodiment shown in FIG. 15, the chat system 10 may have a function to limit a host user's participation in a chat who has created the chat at a host user terminal 20. For example, as shown in FIG. 15, a second register button 217 (a creator nonparticipation chat creation unit) in addition to the register button 214 is displayed on the name input screen 210. When the second register button 217, not the register button 214, is clicked on, the control device 40 displays the invitation screen 22 shown in FIG. 5, on the host user terminal 20. When two or more guest checkboxes 224 are checked on at a user invitation by the invitation screen 220, the control device 40 becomes ready to click on the invitation button 222. When the invitation button 222 clicked on, the control device 40 invites a user selected by the guest checkbox 224 to a created chat but doesn't invite a host user. Therefore, if the second register button 217 is clicked on, participants of a chat created by the control device 40 are composed of only guests invited at the user invitation and doesn't include a host user who has created the chat. Such a chat is effective in the case that it can be created only at the host user terminal 20 but preferably a host user doesn't participate. For example, it is effective in such a case that a host user invites both parties who make a contract with each other, to a chat. In this case, it can be limited that the host user browses a specific contract content between the both parties who make a contract with each other, personal information of the both parties (or the party) (for example, an address, an annual income, account information, and the like), cost, and so on. By way of example, a case is considered when the host user is a real estate agent selling real estate, and invited participants are a service provider, and an owner who buys the real estate. It is effective in such a case that the service provider or the owner doesn't desire the real estate agent who is the host user to browse details on a contract between the real estate agent and the owner or on cost, and personal information of the owner (for example, an annual income, accounting information, or the like). As above, the main screen 100 can display the second register button 217 (a creator nonparticipation chat creation unit) that enables creating a chat that doesn't include a user of a host user terminal 20 as a participant. This assures that the chat system 10 can create a chat in which the host user doesn't participate, at the host user terminal 20, resulting in improving the convenience.

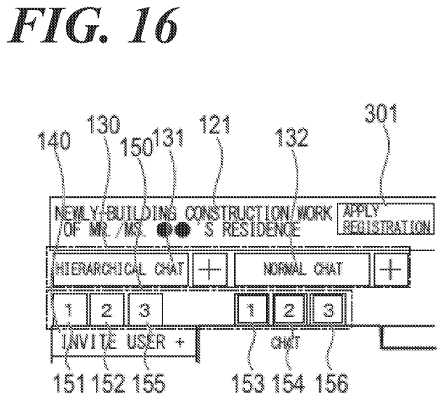

Note that a method for limiting a host user's participation in a chat who has created the chat is not limited to the method of clicking on the second register button 217 installed on the name input screen 210. For example, as in another alternate embodiment shown in FIG. 16, the chat type specification unit 150 may have a fifth button 155 (a creator nonparticipation chat creation unit) that enables creating a group chat in which a host user of a hierarchical chat doesn't participate, and a sixth button 156 (a creator nonparticipation chat creation unit) that enables creating a group chat in which a host user of a normal chat doesn't participate.

In order to create a new group chat being a hierarchical chat in this chat room, when the fifth button 155 is clicked on, the control device 40 displays the invitation screen 220 (See FIG. 5) on the host user terminal 20, so that a plurality of guests can be selected. When a plurality of guests is selected on the invitation screen 220, the control device 40 creates a new group chat that doesn't include a host user as a participant, in this chat room.

In order to create a group chat being a normal chat, when the sixth button 156 is clicked on, the control device 40 displays the invitation screen 220 (See FIG. 5) on the host user terminal 20, so that a plurality of guests can be selected. When a plurality of guests are selected on the invitation screen 220, the control device 40 creates a group chat that doesn't include a host user of a normal chat as a participant, not in this chat room, but as a normal chat.

As above, the main screen 100 may be able to display creator nonparticipation chat creation units (the fifth button 155, the sixth button 156, and the second register button 217) that enable creating a chat that doesn't include a user of a host user terminal 20, who has created a chat, as a participant. This assures that the chat system 10 can create a chat in which a host user doesn't participate, from the main screen 100, at the host user terminal 20, resulting in improving the convenience.

Note that it is preferable that, in a group chat that is created in such a method shown in FIG. 15 or FIG. 16 and that doesn't include a host user as a participant, the host user can't browse a content of the chat at the host user terminal 20. Note that, on the guest user terminal 30 of a participant who participates in the chat, the control device 40 may display a permission button (a permission unit) that adds (invites) a host user as a participant on the invitation screen 220 or that allows the host user to browse the content of the chat though he/she is not a participant. On a host user terminal 20 of a newly added host user, the control device 40 preferably doesn't display a content of a chat before being a participant of the chat but may display it.

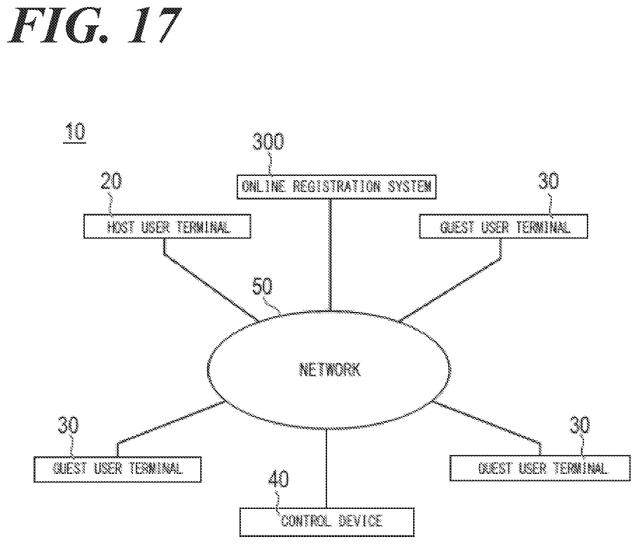

Moreover, as in a further alternate embodiment shown in FIG. 17, the chat system 10 may have a function to register real estate online. The chat system 10 is cooperated with an online application system 300 of Legal Affairs Bureau. Data necessary for registration may be saved as an electronic file posted in a chat room. Therefore, a user who can register real estate (for example, a judicial scrivener, a seller, and a buyer) can start a cooperation with the online application system 300 of the Legal Affairs Bureau, for example by clicking on a register application button 301 (See FIG. 16) at a guest user terminal 30, to make an application directly online on the online application system 300.

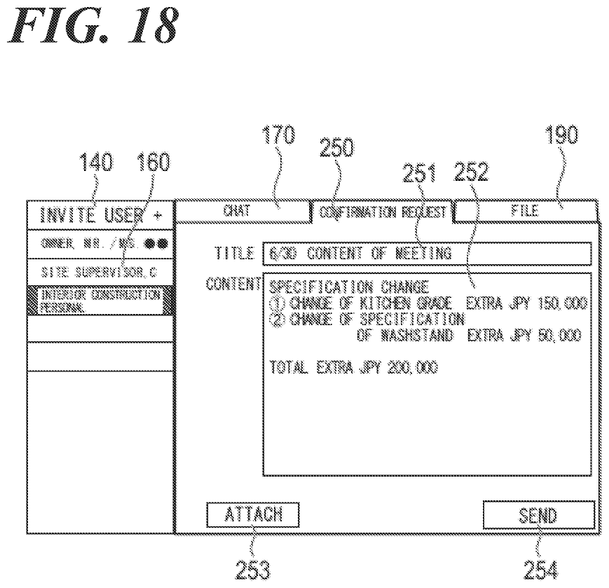

Moreover, as in a further alternate embodiment shown in FIG. 18, the chat system 10 may have a function to easily send an item that a host user desires a guest user to confirm. A main screen 100 displayed on a host user terminal 20 has a confirmation request display unit 250. The confirmation request display unit 250 is displayed with a chat display unit 170 and a file display unit 190 as well as a tab capable of being switched so that any one of screens can be displayed. A tab is a GUI widget for switching documents to be displayed.

On the confirmation request display unit 250, displayed are a title input unit 251 capable of inputting a title of a confirmation request, a request content input unit 252 capable of inputting a content of a confirmation request, a confirmation material attachment unit 253 capable of attaching a material desired to have confirmed, and a request sending unit 254.

The title input unit 251 can input characters at the host user terminal 20. The request content display unit 252 can input characters at the host user terminal 20. The confirmation material attachment unit 253 can specify and select a storage location of an electronic file, and can attach the selected electronic file, by clicking. Note that an electronic file desired to be attached at the host user terminal 20 may be able to be attached by dragging and dropping to the confirmation material attachment unit 253. An attached electronic file may be selected from the file display unit 190 to be ready to be browsed.

The host user selects a tab of the confirmation request display unit 250 in a specific chat selected in a chat room, at the host user terminal 20, and inputs a title into the title input unit 251, as well as inputs an item desired to have confirmed into the request content input unit 252. Subsequently, the host user uses the host user terminal 20 to attach an electronic file desired to have confirmed, with the confirmation material attachment unit 253, if needed. Subsequently, the host user clicks on the request sending unit 254 at the host user terminal 20.

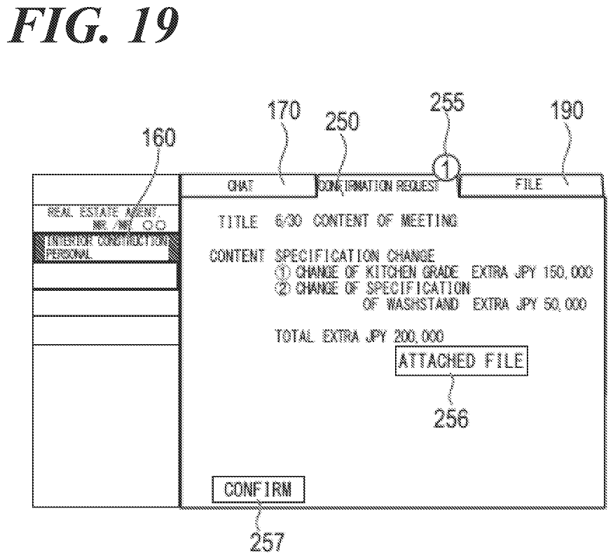

When the request sending unit 254 is clicked on, the control device 40 displays a request reach display 255 showing that a confirmation request has reached on terminals of all guest users and host users who participate in this chat, as shown in FIG. 19. The request reach display 255 may be displayed on an edge of a tag of the confirmation request display unit 250 so as to show the number of unconfirmed confirmation requests.

When a guest user who has received a confirmation request at a guest user terminal 30 selects a tab of the confirmation request display unit 250, the control device 40 displays a title and a content of a confirmation request inputted by the host user terminal 20, on the confirmation request display unit 250, as well as displays an attached file display button 256 for opening and browsing an electronic file, if there is an attached electronic file. Furthermore, the control device 40 displays a confirmation affirmation unit 257 that is a button to be clicked on in order for a user who has confirmed a content of a confirmation request to show that he/she has confirmed, on the confirmation request display unit 250.

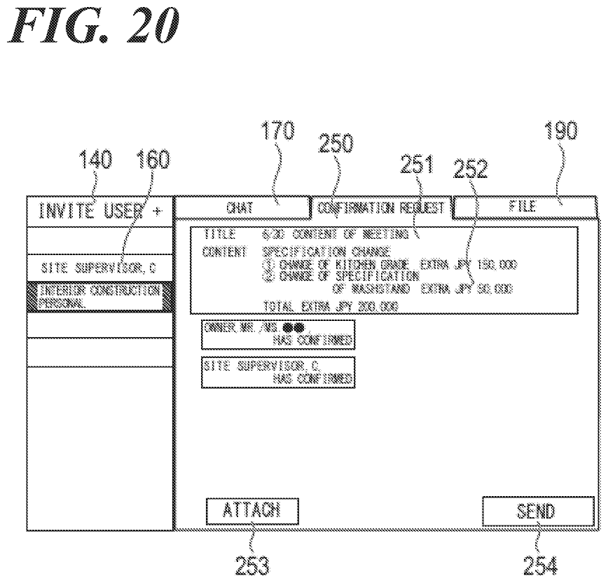

When the confirmation button 257 is clicked on at the guest user terminal 30, the control device 40 displays a name of a guest user who has confirmed and that it has already been confirmed, on the host user terminal 20 that had requested a confirmation, as shown in FIG. 20. Moreover, the control device 40 displays that it has already been confirmed, in the same way, on a guest user terminal 30 at which the confirmation button 257 is clicked on. Moreover, the control device 40 may display that it has already been confirmed, in the same way, on a guest user terminal 30 other than the guest user terminal 30 at which the confirmation button 257 is clicked on, and of a guest user who participates in the same chat, but may not display it.

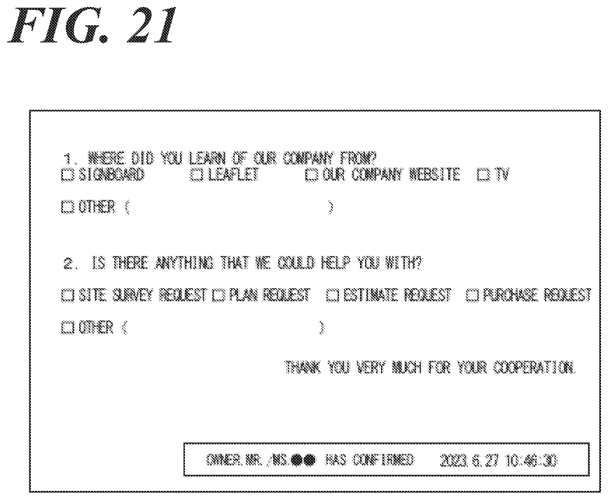

When the attached file display button 256 is clicked on at the guest user terminal 30, the control device 40 opens and displays an attached file such as an image, as browsable, as shown in FIG. 21. Then, when the confirmation button 257 is clicked on at the guest user terminal 30, the control device 40 displays a name of a guest user who has confirmed and that it has already been confirmed, together with date and time, on the first page or the last page of the attached file, as well as saves an updated file. Note that the control device 40 can store and save both an attached file before being updated and an attached file after being updated.

As above, the main screen 100 has a confirmation request display unit 254 that displays, as inputtable, character information to be sent to another user terminal participating in each of the hierarchical chats selected from the chat list display unit 160, and that further displays, as selectable, a confirmation affirmation unit sending inputted character information to the another user terminal, and the control device 40 displays the character information on the another user terminal as well as displays the confirmation affirmation unit 257 that can be selected so as to display it on the main screen 100 of the host user terminal 20 that the character information has been confirmed. This assures that the chat system 10 can easily request a confirmation of information to another user terminal participating in a hierarchical chat at a host user terminal 20 and can easily send it from the another user terminal to the host user terminal 20 that the information has been confirmed, resulting in improving the convenience.

Furthermore, this application is based on Japanese Patent Application No. 2023-032099 filed on Mar. 2, 2023, the disclosed contents of which are referenced and incorporated herein as a whole.

### DESCRIPTION OF REFERENCE SIGNS

10 chat system
20 host user terminal
30 guest user terminal
40 control device (controller)
50 communication network
100 main screen
110 chat room addition unit
120 chat room selection unit

121 chat room name display unit
130 chat type selection unit
131 hierarchical chat creation unit
132 normal chat creation unit
140 user invitation unit
150 chat type specification unit (hierarchical chat creation unit, normal chat creation unit)
155 fifth button (creator nonparticipation chat creation unit)
156 sixth button (creator nonparticipation chat creation unit)
160 chat list display unit
161 grouping unit
163 grouping run button
170 chat display unit
180 chat input unit
200 state switching unit
201 hierarchical chat display selection button
202 normal chat display selection button
217 second register button (creator nonparticipation chat creation unit)
250 confirmation request display unit
254 request sending unit

1.-7. (canceled)

8. A chat system connected via a communication network to a plurality of user terminals including at least one host user terminal to enable chatting where a plurality of specific users make a post and browse a post content on a common screen, comprising:
a controller having a display processing function to display a main screen on a display panel of at least the host user terminal, wherein
the main screen further comprises:
a chat room selection unit displaying, as selectable, a chat room in which the host user terminal can be participated and to which at least one chat can belong;
a hierarchical chat creation unit capable of adding at least one chat belonging to the chat room selected, where each of chats belonging to the chat room is a one-to-one chat or a group chat of more than three persons including a host user;
a chat list display unit that displays, as selectable, the chat which belongs to the chat room selected and which can be participated in at the host user terminal,
being capable of displaying a grouping unit that selects at least two of the chats and that creates a new chat room to which the chats selected belong, and
and being capable of making a post to each of the chats selected from the chat list display unit and furthermore capable of posting the same content in a batch to each of a plurality of the chats selected from the chat list display unit.

9. A chat system connected via a communication network to a plurality of user terminals including at least one host user terminal to enable chatting where a plurality of specific users make a post and browse a post content on a common screen, comprising:
a controller having a display processing function to display a main screen on a display panel of at least the host user terminal, wherein
the main screen further comprises:
a chat room selection unit displaying, as selectable, a chat room in which the host user terminal can be participated and to which at least one chat can belong;
a hierarchical chat creation unit capable of adding at least one chat belonging to the chat room selected, where each of chats belonging to the chat room is a one-to-one chat or a group chat of more than three persons including a host user;
a chat list display unit that displays, as selectable, the chat which belongs to the chat room selected and which can be participated in at the host user terminal; and
a state switching unit capable of switching a state of displaying a chat belonging to the chat room and a state of displaying a normal chat being a chat that doesn't have a chat room to which it belongs,
the main screen can display both the hierarchical chat creation unit and a normal chat creation unit that can add the normal chat, in at least one state of either a state of displaying a chat belonging to the chat room or a state of displaying the normal chat, and
being capable of making a post to each of the chats selected from the chat list display unit and furthermore capable of posting the same content in a batch to each of a plurality of the chats selected from the chat list display unit.

10. A chat system connected via a communication network to a plurality of user terminals including at least one host user terminal to enable chatting where a plurality of specific users make a post and browse a post content on a common screen, comprising:
a controller having a display processing function to display a main screen on a display panel of at least the host user terminal, wherein
the main screen further comprises:
a chat room selection unit displaying, as selectable, a chat room in which the host user terminal can be participated and to which at least one chat can belong;
a hierarchical chat creation unit capable of adding at least one chat belonging to the chat room selected, where each of chats belonging to the chat room is a one-to-one chat or a group chat of more than three persons including a host user;
a chat list display unit that displays, as selectable, the chat which belongs to the chat room selected and which can be participated in at the host user terminal, and
being capable of displaying a grouping unit that selects at least two of the chats and that creates a new chat room to which the chats selected belong.

11. A chat system connected via a communication network to a plurality of user terminals including at least one host user terminal to enable chatting where a plurality of specific users make a post and browse a post content on a common screen, comprising:
a controller having a display processing function to display a main screen on a display panel of at least the host user terminal, wherein
the main screen further comprises:
a chat room selection unit displaying, as selectable, a chat room in which the host user terminal can be participated and to which at least one chat can belong;
a hierarchical chat creation unit capable of adding at least one chat belonging to the chat room selected, where each of chats belonging to the chat room is a one-to-one chat or a group chat of more than three persons including a host user;
a chat list display unit that displays, as selectable, the chat which belongs to the chat room selected and which can be participated in at the host user terminal;
a state switching unit capable of switching a state of displaying a chat belonging to the chat room and a state of displaying a normal chat being a chat that doesn't have a chat room to which it belongs, and
the main screen can display both the hierarchical chat creation unit and a normal chat creation unit that can add the normal chat, in at least one state of either a state of displaying a chat belonging to the chat room or a state of displaying the normal chat.

12. A chat processing method achieved by a controller connected via a communication network to a plurality of user terminals including at least one host user terminal to enable chatting where a plurality of specific users make a post and browse a post content on a common screen,
and comprising: a step of displaying a main screen on a display panel of at least the host user terminal;
a step of displaying a chat room selection unit that displays, as selectable, a chat room in which the host user terminal can be participated and to which at least one chat can belong, on the main screen;
a step of displaying a hierarchical chat creation unit capable of adding at least one chat belonging to the chat room selected, where each of chats belonging to the chat room is a one-to-one chat or a group chat of more than three persons including a host user, on the main screen;
a step of displaying a chat list display unit that displays, as selectable, the chat which belongs to the chat room selected and which can be participated in at the host user terminal, on the main screen; and
a step of displaying a grouping unit that can select at least two of the chats and that creates a new chat room to which the chats selected belong, on the main screen.

13. A chat processing method achieved by a controller connected via a communication network to a plurality of user terminals including at least one host user terminal to enable chatting where a plurality of specific users make a post and browse a post content on a common screen, comprising:
a step of displaying a main screen on a display panel of at least the host user terminal;
a step of displaying a chat room selection unit that displays, as selectable, a chat room in which the host user terminal can be participated and to which at least one chat can belong, on the main screen;
a step of displaying a hierarchical chat creation unit capable of adding at least one chat belonging to the chat room selected, where each of chats belonging to the chat room is a one-to-one chat or a group chat of more than three persons including a host user, on the main screen;
a step of displaying a chat list display unit that displays, as selectable, the chat which belongs to the chat room selected and which can be participated in at the host user terminal, on the main screen;
a step of displaying a state switching unit capable of switching a state of displaying a chat belonging to the chat room and a state of displaying a normal chat being a chat that doesn't have a chat room to which it belongs, on the main screen; and
a step of displaying both the hierarchical chat creation unit and a normal chat creation unit capable of adding the normal chat, on the main screen, in at least one state of either a state of displaying a chat belonging to the chat room on the chat room or a state of displaying the normal chat.
